(19) United States
(12) Patent Application Publication
(10) Pub. No.: US 2023/0021649 A1
(43) Pub. Date: Jan. 26, 2023

(54) INFORMATION PROCESSING DEVICE, INFORMATION PROCESSING METHOD, AND PROGRAM

(71) Applicant: Tetsuya ONO, Sagamihara-shi (JP)

(72) Inventor: Tetsuya ONO, Sagamihara-shi (JP)

(21) Appl. No.: 17/788,157

(22) PCT Filed: Jan. 21, 2021
(86) PCT No.: PCT/JP2021/002013

§ 371 Date: Jun. 22, 2022

(30) Foreign Application Priority Data
Jan. 24, 2020 (JP) 2020-009804

(51) Int. Cl. G06Q 10/06; G06Q 50/02; G05D 1/02

(52) U.S. Cl. CPC G06Q 10/06316; G06Q 10/063114; G06Q 50/02; G05D 1/0291; G05D 1/0248; G05D 1/0219; G05D 2201/0201

(57) ABSTRACT

A work management system for managing work to be performed on a work subject. The work management system includes multiple work robots, a storage unit, a generator, and an instruction unit. The work robots each include movement means capable of moving to any location. The storage unit stores target information on a target state of the work subject and current state information on a current state of the work subject. The generator generates work procedure information indicating a work procedure to be performed by the work robots so that the work subject is brought close to the target state, on the basis of the target information and the current state information. The work procedure information includes work instruction information for instructing the work robots to perform one or more types of work to be performed on the work subject.

### FIELD

The present invention relates to an information processing device, information processing method, and program.

### BACKGROUND

Work devices that autonomously move are known. For example, a work device equipped with task-specific work tools autonomously moves on the ground. These work tools are assigned to different work modules. The different work modules are selectively used by the work device. The work modules serve as, for example, a watering tool, a pruning tool, a mowing tool, a sweeping tool, a fertilizing tool, and a soil treatment tool. Care for planted plants is performed with the aid of plan support means including a database. The plan support means transmits task data to the work device (for example, see Reference 1). Also, printers formed by incorporating a print head into an unattended flying object called a drone are known (for example, see Reference 2).

Methods and devices that support mobile additive material processing are also known. Such a method includes, for example, processing a layer having large dimensions for generating large parts having a three-dimensional shape to be joined together (for example, see Reference 3).

Automated methods for producing a three-dimensional object and texture processing substrate from a two-dimensional or three-dimensional object are also known (for example, see Reference 4).

### PATENT LITERATURE

[Patent Literature 1] Japanese Unexamined Patent Application Publication No. 2019-022482
[Patent Literature 2] Japanese Unexamined Patent Application Publication No. 2019-042954
[Patent Literature 3] Japanese Unexamined Patent Application Publication (Translation of PCT Application) No. 2016-535687
[Patent Literature 4] Japanese Unexamined Patent Application Publication (Translation of PCT Application) No. 2008-518290

### SUMMARY

A work device described in Patent Literature 1 causes one device to perform one task. For example, in pruning, this work device causes one device to perform one task from the beginning to the end. However, causing one device to perform one task from the beginning to the end increases the number of given functions or the amount of given information.

The following technologies have individual problems. 3D printer: generally, there is a limit to the size of an object to be printed (constructed). 3D scanner: generally, there is a limit to the size of an object to be scanned, and it is difficult to accurately capture coordinate information in a wide range.

Unattended work execution in construction industry: there have been attempts such as remote operation of heavy equipment and assembly of previously factory produced parts using work devices (robots, etc.). However, personnel (operators, etc.) are required in many cases, and unattended work execution has yet to be realized.

Construction work, pruning work of trees (planted plants, street trees, etc.), or the like: personnel, temporary equipment (scaffolding, etc.), safety measures, and the like are required, and the workable time zone is limited in many cases. The transportation of materials or material waste is also limited (for example, a large vehicle may be required in a narrow work range). In one aspect, an object of the present invention is to allow work to be performed on a work subject located in any site such as a building or trees, with a high degree of freedom.

One aspect of the present invention provides a work management system for managing work to be performed on a work subject. The work management system includes multiple work robots, a storage unit, a generator, and an instruction unit. The work robots each include movement means capable of moving to any location. The storage unit stores goal information on a target state of the work subject and current state information on a current state of the work subject. The generator generates work procedure information indicating a work procedure to be performed by the work robots so that the work subject is brought close to the target state, on the basis of the goal information and the current state information. The work procedure information includes work instruction information for instructing the work robots to perform one or more types of work to be performed on the work subject. The instruction unit transmits one piece of work instruction information to be performed by the work robots to the work robots on the basis of the work procedure information and, when receiving work completion information based on the work instruction information, transmits the next work instruction information on work to be performed subsequent to the work, to the work robots.

In the one aspect, the work is allowed to be performed with a high degree of freedom.

### BRIEF DESCRIPTION OF DRAWINGS

FIG. 1 is a drawing showing an information processing system according to a first embodiment.

FIG. 2 is a drawing showing the hardware configuration of the information processing device according to the embodiments.

FIG. 3 is a drawing showing the hardware configuration of a work robot according to the embodiments.

FIG. 4 is a block diagram showing the functions of the information processing device according to the embodiments.

FIG. 5 is a flowchart showing an outline of a process performed by the information processing system.

FIG. 6 is a flowchart showing a current state grasp process according to the first embodiment.

FIG. 7 is a flowchart showing a work sequence generation process and instruction information transmission process according to the first embodiment.

FIG. 8 is a flowchart showing a work execution process and work completion report process according to the first embodiment.

FIG. 9 is a flowchart showing a given conditions acquisition process performed by an information processing device according to a second embodiment.

FIG. 10 is a flowchart showing a current state grasp process according to the second embodiment.

FIG. 11 is a flowchart showing a work sequence generation process and instruction information transmission process according to the second embodiment.

FIG. 12 is a drawing showing an information processing system according to a third embodiment.

FIG. 13 is a flowchart showing a given conditions acquisition process according to the third embodiment.

FIG. 14 is a flowchart showing a current state grasp process according to the third embodiment.

FIG. 15 is a flowchart showing the current state grasp process according to the third embodiment.

FIG. 16 is a flowchart showing a work sequence generation process and instruction information transmission process according to the third embodiment.

FIG. 17 is a drawing showing an information processing system according to another embodiment.

### DETAILED DESCRIPTION

Information processing systems according to embodiments will be described below in detail with reference to the drawings.

The position, size, shape, range, or the like of the components shown in the following drawings or the like may not represent the actual position, size, shape, range, or the like thereof. This is intended to facilitate the understanding of the invention. For this reason, the present invention is not necessarily limited to the position, size, shape, range, or the like disclosed in the drawings or the like. Singular components described in the embodiments include plural forms unless explicitly stated in the description.

### First Embodiment

One object of an information processing system according to a first embodiment is to solve the following two problems.

(1) Unattended work execution in construction industry:

There are technologies for performing drilling or the like by remotely operating heavy equipment. However, work based on remote operation often requires personnel (operators) who operate heavy equipment from a remote location or personnel (instructors) who make instructions to operators near the work site. Also, there have been attempts, including assembly of parts such as previously factory produced precast concrete pillars or beams using a robot. However, accurate assembly of such parts often require personnel (workers) who adjust the installation position of the parts. For these reasons, complete unattended work execution has yet to be realized.

### (2) Construction Work:

In general, construction work requires many personnel, and it is necessary to increase work efficiency and ensure safety by providing temporary equipment (scaffolding, etc.) or safety equipment (fall prevention net, etc.) and taking measures on safety and health (work time management, etc.). It is also necessary to consider neighbors by limiting the work time zone or taking measures to prevent noise or the like associated with work. Moreover, the selection of the work device, the transportation route of materials or the like, and the placement, turn, or the like of heavy equipment are limited by the work range conditions.

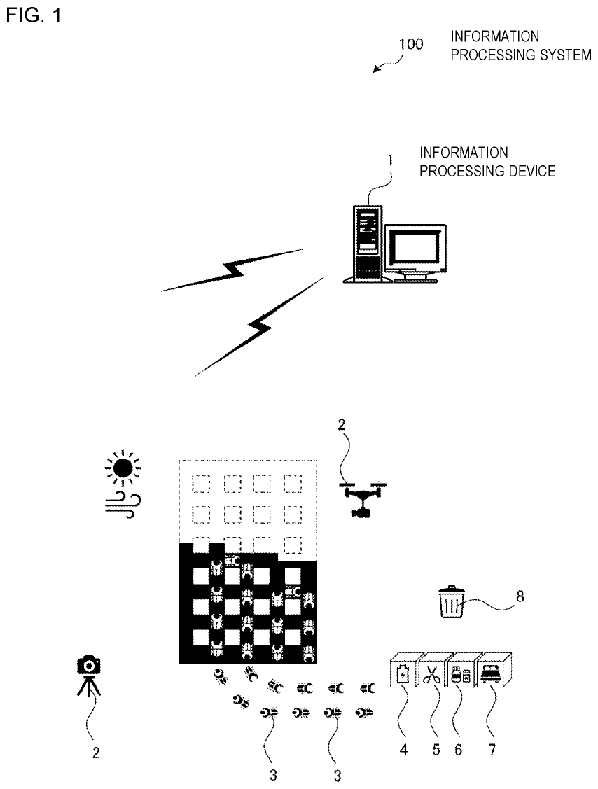

FIG. 1 is a drawing showing the information processing system according to the first embodiment. An information processing system 100 according to the first embodiment includes an information processing device 1, an external sensor 2, multiple work robots 3, a charger 4, a consumables warehouse 5, a repair unit 6, a storage 7, and a waste storage 8.

The information processing device 1 stores goal information on the target state of a work subject and state information on the current state of the work subject. The work subject is, for example, a building. Examples of details of the work include the construction or repair of a building and the transportation of materials. In the present embodiment, it is assumed that the work subject is a building.

The goal information is information previously provided from outside. For example, in the case of a building, the goal information is coordinate information of the finished form (information indicating that the building is located at predetermined coordinates and is not located at other coordinates). The current state information is information obtained by performing a measurement or the like. For example, in the case of a building, the current state information is coordinate information of the building currently under construction.

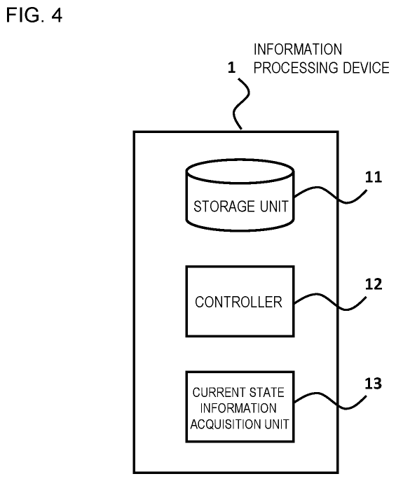

The external sensor 2 is used when a current state information acquisition unit 13 (see FIG. 4) acquires current state information. The external sensor 2 includes one or more sensors for detecting various measurement results in the environment surrounding the work subject, such as an image sensor, a thermometer, a hygrometer, an anemometer, an infrared meter, an ultraviolet meter, a microphone, and a seismic intensity meter. The external sensor 2 may also include any type of movement means such as flight means, running means, or navigation means.

The work robots 3 perform construction of a building. Each work robot 3 has a function of transmitting and receiving data to and from the information processing device 1. Each work robot 3 has a unique ID, and the information processing device 1 identifies the work robot 3 through this ID. Information collected by the work robots 3 is transmitted to the information processing device 1 and stored.

Each work robot 3 includes movement means capable of moving to any location. As used herein, the term “any location” refers to any location on land, in the air, in the ground, underwater, in the deep sea, or in outer space. To realize this, each work robot 3 is allowed to perform a movement behavior such as walking, sliding, climbing, rolling, flying, swimming, diving, or drilling using the movement means. Each work robot 3 may perform a movement to any location by combining these movement behaviors. In other words, it is only necessary to employ an existing technology capable of realizing each movement behavior as movement means. Which type of movement means each work robot 3 should include is determined in accordance with the installation position and shape of the work subject.

Also, each work robot 3 may have various functions in accordance with the work subject. While each work robot 3 is in the shape of a stag beetle and has a material addition/transportation function in FIG. 1, this shape or function is, of course, not limiting. The size of each work robot 3 may be the size of an insect that roams around the building, for example, the size of an ant or wasp. Thus, the building can be constructed even if work scaffolding or the like is not provided. Note that each work robot 3 may have the functions of the external sensor 2.

Each work robot 3 need not necessarily have multiple functions during work. For example, one work robot 3 may have only an addition function in addition to the movement means, and another work robot 3 may have only a foreign matter removal function in addition to the movement means. Each work robot 3 repeats simple work so that the target shape or state of the building is obtained when the work is complete, as is done by a 3D printer.

The charger 4 charges the rechargeable battery of each work robot 3. The consumables warehouse 5 is storing consumables (e.g., materials or adhesives) transported by the work robots 3. The repair unit 6 has a function of repairing the work robots 3. The storage 7 is a place for storing the work robots 3. The storage 7 may have a function of charging the rechargeable batteries of the work robots 3. The waste storage 8 is a place for storing waste generated in association with the work of the work robots 3.

Each work robot 3 has a function of maintaining a state in which the work robot 3 is able to perform its own function. For example, if one work robot 3 runs out of consumables, it moves to the consumables warehouse 5 and replenishes itself with consumables regardless of whether there is instruction information from the information processing device 1.

Next, a process performed by the information processing system 100 will be described briefly. The information processing device 1 generates work procedure information for causing the work robots 3 to perform the work of bringing the work subject close to the target state, on the basis of the goal information and current state information. For example, if foreign matter is adhering to the building, the information processing device 1 first generates first work instruction information for removing the foreign matter. When the foreign matter is removed, the information processing device 1 generates second work instruction information for newly adding a material to the building. The work procedure information is generated by compiling previously acquired coordinate information and work situation of the work robots 3 and information on the position and situation of the work subject.

The information processing device 1 transmits, to the work robots 3, first work instruction information to be performed by the work robots 3 on the basis of the generated work procedure information. The first work instruction information here is, for example, information instructing the work robots 3 to perform the same type of detailed work, in the work procedure information. A specific example of the first work instruction information is information instructing the work robots 3 to move to the building under construction, to climb up the building, to remove foreign matter in an amount removable by the work robots 3, and to transport the removed foreign matter to the waste storage 8. As seen above, the information processing device 1 sequentially issues, to the work robots 3, work instruction information instructing the work robots 3 to repeatedly perform the same type of detailed work. Thus, such work is repeated, resulting in final completion of the building.

Specifically, the work robots 3 move toward the coordinates of the target building in order to perform work all at once on the basis of the first work instruction information. The work robots 3 then arrive at the target site and sequentially start to perform work. For example, ten work robots 3 start to remove foreign matter in different positions. If there are work robots 3 that are already located in the target site, other work robots 3 that have yet to arrive at the target site may wait near the target site. If one work robot 3 removing foreign matter determines that it cannot remove foreign matter anymore, it may transport the removed foreign matter to the waste storage 8 even if foreign matter remains at that point in time. In this case, another work robot 3 that subsequently arrives at the target site performs the work of removing the remaining foreign matter.

If one work robot 3 removing foreign matter removes the foreign matter completely or cannot remove the foreign matter anymore, it may determine that it has completed the work based on the first work instruction information.

When the information processing device 1 receives work completion information from a work robot 3 that has completed the work based on the first work instruction information earliest among the work robots 3 (an example of the “receiving process” in the claims), it transmits second work instruction information next to the first work instruction information to the work robots 3. For example, the second work instruction information is information instructing the work robots 3 to add a material to the building under construction. Thus, the work robots 3 move toward the coordinates of the target building in order to perform work all at once. Note that if there are multiple pieces of second work instruction information in parallel at the same timing, for example, if there are building construction work and building coating work at the same timing, the information processing device 1 may group the work robots 3 by work type and cause the groups to perform the work in parallel.

As seen above, the work robots 3 continue to perform the detailed work (removal of foreign matter, addition of a material, etc.) in order to bring the work subject close to the target state, on the basis of the instruction information from the information processing device 1. Thus, the building is completed.

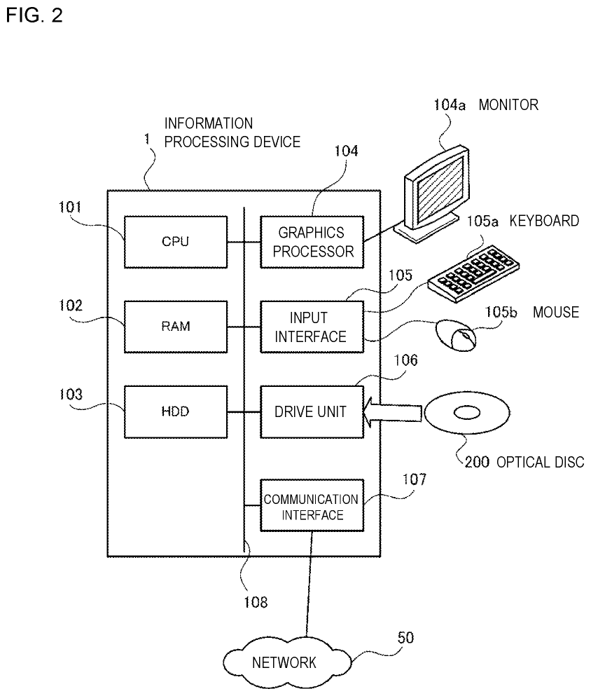

The information processing system 100 according to the present disclosure will be described below more concretely. FIG. 2 is a drawing showing the hardware configuration of the information processing device according to the embodiments. The entire information processing device 1 is controlled by a CPU (central processing unit) 101. A RAM (random access memory) 102 and multiple peripheral devices are connected to the CPU 101 through a bus 108.

The RAM 212 is used as the main memory of the information processing device 1. At least some of the programs of an operating system (OS) or application programs executed by the CPU 101 are temporarily stored in the RAM 102. Various types of data used in processing performed by the CPU 101 are also stored in the RAM 102.

An HDD (hard disk drive) 103, a graphics processor 104, an input interface 105, a drive unit 106, and a communication interface 107 are connected to the bus 108.

The hard disk drive 103 magnetically writes and reads data to and from a built-in disk. The hard disk drive 103 is used as the secondary memory of the information processing device 1. The programs of the OS, application programs, and various types of data are stored in the hard disk drive 103. Note that a semiconductor memory such as a flash memory may be used as the secondary memory.

A monitor 104a is connected to the graphics processor 104. The graphics processor 104 displays an image on the screen of the monitor 104a in accordance with an instruction from the CPU 101. Examples of the monitor 104a include displays using a cathode ray tube (CRT) and liquid crystal displays.

A keyboard 105a and a mouse 105b are connected to the input interface 105. The input interface 105 transmits signals transmitted from the keyboard 105a or mouse 105b to the CPU 101. Note that the mouse 105b is an example of a pointing device and another type of pointing device may be used. Examples of the other type of pointing device include a touchscreen, a tablet, a touch pad, and a track ball.

The drive unit 106 reads data stored in a transportable storage medium such as an optical disc in which data is stored so as to be read by reflection of light or a universal serial bus (USB) memory. For example, if the drive unit 106 is an optical drive unit, it reads data stored in an optical disc 200 using laser light or the like. Examples of the optical disc 200 include a Blu-ray® disc, a DVD (digital versatile disc), a DVD-RAM, a CD-ROM (compact disc read-only memory), and a CD-R (recordable)/RW (rewritable).

The communication interface 107 is connected to a network 50. The communication interface 107 transmits and receives data to and from other computers or communication devices through the network 50. The processing functions of the information processing device 1 according to the present embodiment are implemented by the hardware configuration described above.

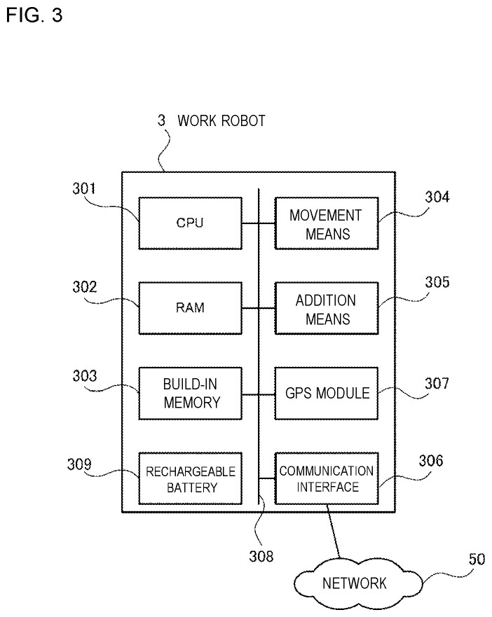

FIG. 3 is a drawing showing the hardware configuration of a work robot according to the embodiments. The entire work robot 3 is controlled by a CPU (central processing unit) 301. A RAM (random access memory) 302 and multiple peripheral devices are connected to the CPU 301 through a bus 308. The RAM 302 is used as the main memory of the work robot 3.

At least some of the programs of an operating system (OS) or application programs executed by the CPU 301 are temporarily stored in the RAM 302. Various types of data used in processing by the CPU 301 are also stored in the RAM 302. A build-in memory 303, movement means 304, addition means 305, a communication interface 306, and a GPS module 307 are connected to the bus 308.

Data is written to and read from the build-in memory 303. The build-in memory 303 is used as the secondary memory of the work robot 3. The programs of the OS, application programs, and various types of data are stored in the build-in memory 303. The build-in memory 303 is, for example, a semiconductor memory such as a flash memory.

The movement means 304 is means that moves the work robot 3 to the target site using wheels, caterpillars, legs, suckers, propellers, wings or the like on the basis of instruction information from the CPU. The addition means 305 is means that causes the work robot 3 to add a material using a material storage tank, addition nozzle, or the like on the basis of instruction information from the CPU.

The communication interface 306 is connected to the network 50. The communication interface 306 transmits and receives data to and from other computers or communication devices through the network 50.

The GPS module 307 acquires coordinate information (latitude, longitude, and altitude) of the work robot 3. For example, this coordinate information is transmitted to the information processing device 1 by the CPU 301 through the communication interface 306. Note that the method for acquiring coordinate information is not limited to the method using the GPS module 307 and may be, for example, a method of calculating the coordinates using a reference point fixed to the ground, image processing, or the like

A rechargeable battery 309 supplies power that drives the work robot 3. The processing functions of the work robot 3 according to the present embodiment are implemented by the hardware configuration described above.

FIG. 4 is a block diagram showing the functions of the information processing device 1 according to the present embodiment. The information processing device 1 includes a storage unit 11, a controller 12, and the current state information acquisition unit 13. The above-mentioned target information and current state information are stored in the storage unit 11. The controller 12 has a function of acquiring information from the work robots 3 and functions as a generator that generates instruction information to be provided to the work robots 3 and an instruction unit that transmits instruction information to the work robots 3. The current state information acquisition unit 13 acquires current state information on the basis of information detected by the external sensor 2.

Next, a process performed by the information processing system 100 will be described with reference to a flowchart. Note that the following flowchart is illustrative only and other processes may be added, or some processes may be omitted, or the sequence of some processes may be changed, or some processes may be performed in parallel.

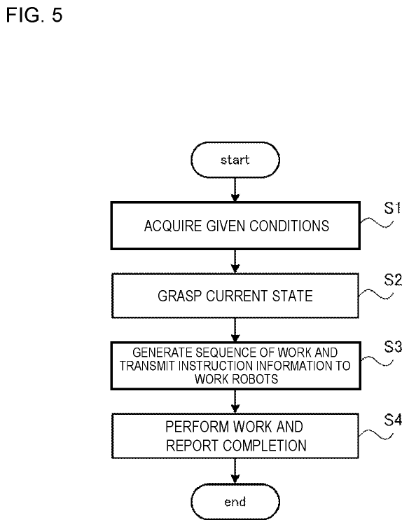

FIG. 5 is a flowchart showing an outline of the process performed by the information processing system. The process shown in FIG. 5 is common to the first embodiment and second and third embodiments (to be discussed later).

[Step S1] The controller 12 refers to the storage unit 11. The controller 12 also refers to information acquired from outside. The controller 12 then grasps the previously given completed form of the work subject (given conditions acquisition process).

[Step S2] The controller 12 grasps the current state (current state grasp process).

[Step S3] The controller 12 generates the sequence of work to be performed by the work robots 3 (work sequence generation process) and transmits instruction information to be performed by the work robots 3 to the work robots 3 in accordance with the generated sequence of work (instruction information transmission process).

[Step S4] The work robots 3 receive the instruction information and perform the work. When one work robot 3 completes the work, the work robot 3 transmits a completion report to the information processing device 1. Next, details of the steps will be described.

First, the given conditions acquisition process of step S1 will be described. Information on the shape or specification of the building to be constructed (given conditions) is predetermined input information. For this reason, the information processing system according to the first embodiment does not perform the given conditions acquisition process.

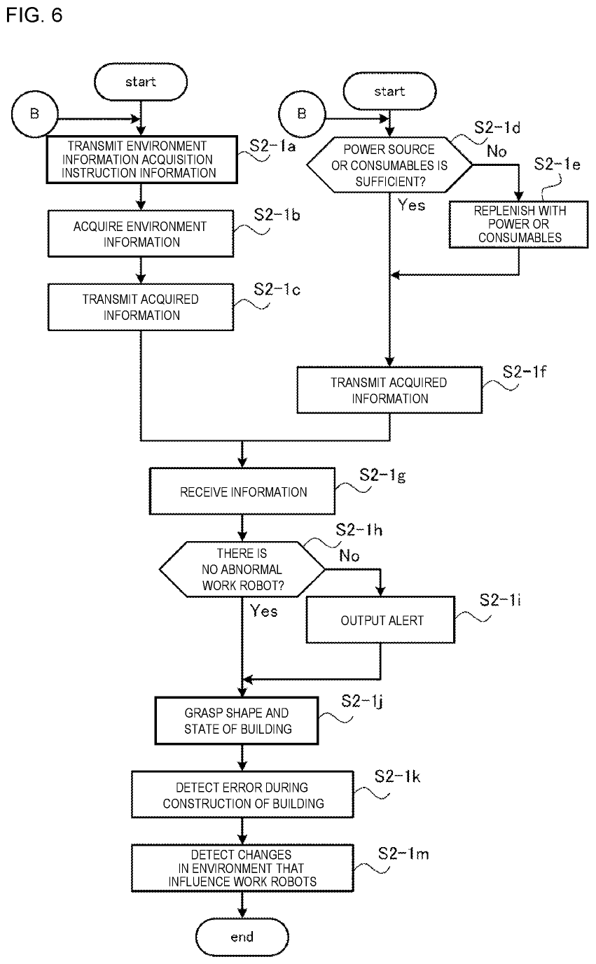

Next, the current state grasp process of step S2 will be described. FIG. 6 is a flowchart showing the current state grasp process according to the first embodiment.

[Step S2-1a] The controller 12 transmits environment information acquisition instruction information to the external sensor 2.

[Step S2-1b] The external sensor 2 acquires environment information such as image information, weather, atmospheric temperature, sunshine, and wind speed. Then, the process proceeds to step S2-1c.

[Step S2-1c] The external sensor 2 transmits the acquired environment information to the information processing device 1.

[Step S2-1d] Each work robot 3 checks the remaining amount of each power sources (rechargeable battery) and the presence or absence of a problem such as a shortage of consumables. If a work robot 3 has a problem (NO in step S2-1d), the process of the work robot 3 proceeds to step S2-1e. If the work robot 3 has no problem (YES in step S2-1d), the process of the work robot 3 proceeds to step S2-1f.

[Step S2-1e] The work robot 3 moves to the charger 4 or consumables warehouse 5 and replenishes itself with power or consumables. Then, the process proceeds to step S2-1f.

[Step S2-1f] The work robots 3 move within the work range including the surface of the building and transmit acquired information to the information processing device 1. The work robots 3 also transmit coordinate information to the information processing device 1.

[Step S2-1g] The controller 12 of the information processing device 1 receives the information transmitted by the external sensor 2 and work robots 3. Then, the process proceeds to step S2-1h.

[Step S2-1h] The controller 12 analyzes the information received in step S2-1g an determines whether there is an abnormal work robot 3. For example, if there is a work robot 3 that has not transmitted information for a predetermined time or a work robot 3 whose coordinates have not been changed, the controller 12 determines that the work robot 3 is abnormal.

If there is an abnormal work robot 3 (NO in step S2-1h), the process proceeds to step S2-1i. If there is no abnormal work robot 3 (YES in step S2-1h), the process proceeds to step S2-1j.

[Step S2-1i] The controller 12 displays an alert screen on the monitor 104a. Then, the process proceeds to step S2-1j.

[Step S2-1j] The controller 12 analyzes the information received in step S2-1g and grasps the shape and state of the building. Then, the process proceeds to step S2-1k.

[Step S2-1k] The controller 12 analyzes the information received in step S2-1g and determines whether an error is occurring during the construction of the building. For example, the controller 12 makes a comparison between the previously given completed form of the work subject and the analysis results of the information received in step S2-1g. If there is a discrepancy therebetween, the controller 12 determines that an error is occurring.

[Step S2-1m] The controller 12 analyzes the information received in step S2-1g and detects changes in the environment that influence the work robots 3.

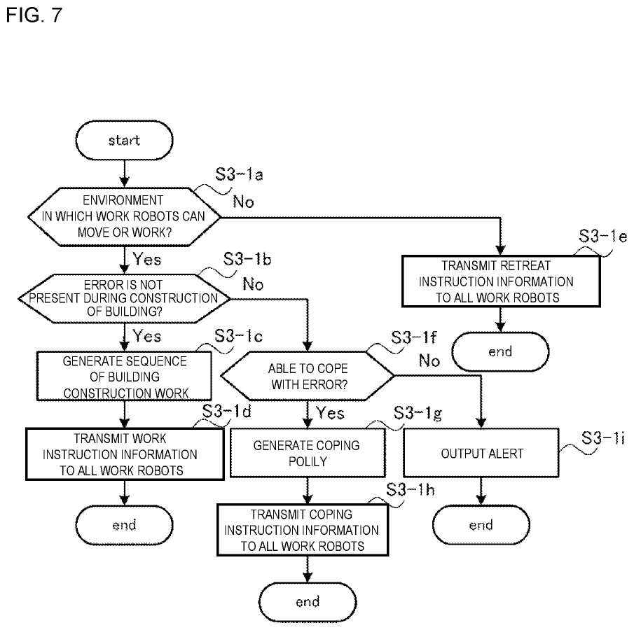

Next, the work sequence generation process and instruction information transmission process of step S3 will be described. FIG. 7 is a flowchart showing the work sequence generation process and instruction information transmission process according to the first embodiment.

[Step S3-1a] The controller 12 determines whether the environment is an environment in which the work robots 3 can move or work, on the basis of the detection results of step S2-1m. If it is determined that the environment is an environment in which the work robots 3 can move or work (YES in step S3-1a), the process proceeds to step S3-1b. If it is determined that the environment is an environment in which the work robots 3 cannot move or work (NO in step S3-1a), the process proceeds to step S3-1e.

[Step S3-1b] The controller 12 determines whether an error is occurring during the construction of the building, on the basis of the detection results of step S2-1k. If no error is occurring during the construction of the building (YES in step S3-1b), the process proceeds to step S3-1c. If an error is occurring during the construction of the building (NO in step S3-1b), the process proceeds to step S3-1f.

[Step S3-1c] The controller 12 generates the sequence of the building construction work.

[Step S3-1d] The controller 12 transmits work instruction information to all the work robots 3. All the work robots 3 receive the work instruction information and start the building construction work. While, in the present embodiment, all the work robots 3 are caused to sequentially perform the same type of work, The number or range of work robots 3 to be caused to perform work may be limited. For example, if there are multiple work locations, work instruction information with respect to one work location may be transmitted to some work robots 3 close to the work location and work instruction information with respect to another work location may be transmitted to some work robots 3 close to the other work location.

[Step S3-1e] The controller 12 transmits, to all the work robots 3, information instructing the work robots 3 to retreat to the storage 7.

[Step S3-1f] The controller 12 determines whether the work robots 3 are able to cope with the error. For example, the controller 12 determines whether the work robots 3 are able to repair a predetermined portion, for example, by grinding the portion. If it is determined that the work robots 3 are able to cope with the error (YES in step S3-1f), the process proceeds to step S3-1g. If it is determined that the work robot 3 are not able to cope with the error (NO in step S3-1f), the process proceeds to step S3-1i.

[Step S3-1g] The controller 12 generates coping policy. Then, the process proceeds to step S3-1h.

[Step S3-1h] The controller 12 transmits coping instruction information based on the coping policy to all the work robots 3.

[Step S3-1i] The controller 12 displays an alert screen on the monitor 104a.

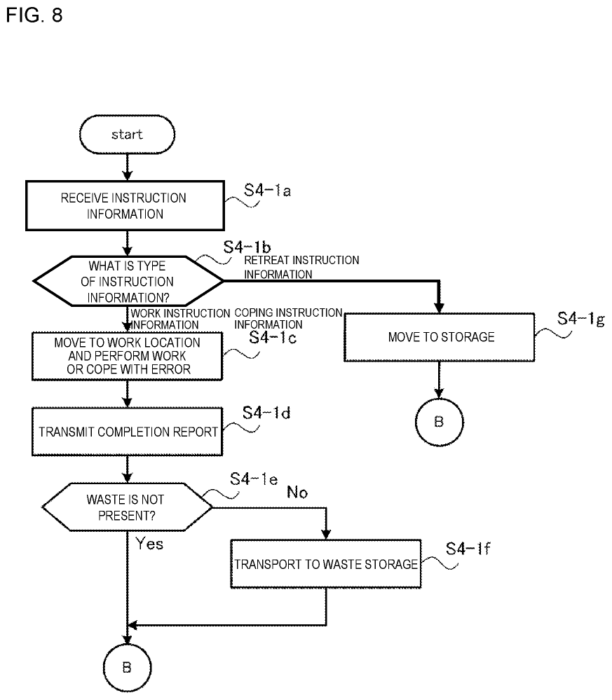

FIG. 8 is a flowchart showing a work execution process and work completion report process according to the first embodiment.

[Step S4-1a] The work robots 3 receive instruction information from the information processing device 1. Then, the process proceeds to step S4-1b.

[Step S4-1b] The work robots 3 determine the type of the instruction information received in step S4-1a. If the type of the instruction information is work instruction information or coping instruction information (the work instruction information or coping instruction information of step S4-1b), the process proceeds to step S4-1c. If the type of the instruction information is retreat instruction information (the retreat instruction information of step S4-1b), the process proceeds to step S4-1g.

[Step S4-1c] The work robots 3 move to the work location and perform work in accordance with the instruction information. Specifically, if the instruction information is work instruction information, the work robots 3 perform addition of a material, welding, fitting, or the like. If the instruction information is coping instruction information, the work robots 3 perform grinding work, removal work, or the like to recover from the error. When the work is complete, the process proceeds to step S4-1d.

[Step S4-1d] A work robot 3 that has completed the work earliest transmits a completion report to the information processing device 1. Then, the process proceeds to step S4-1e.

[Step S4-1e] The work robots 3 determine whether there is waste. If there is no waste (YES in step S4-1e), the process proceeds to steps S2-1a and S2-1d of FIG. 6 and the processes of steps S2-1a and S2-1d and later are continuously performed. If there is waste (NO in step S4-1e), the process proceeds to step S4-1f.

[Step S4-1f] The work robots 3 transport the waste to the waste storage 8. Then, the process proceeds to steps S2-1a and S2-1d of FIG. 6, and the processes of steps S2-1a and S2-1 d and later are continuously performed.

[Step S4-1g] The work robots 3 move to the storage 7. Then, the process proceeds to step S2-1a and S2-1d of FIG. 6, and the processes of step S2-1a and S2-1d and later are continuously performed.

As described above, in the information processing system 100, the information processing device 1 includes the storage unit 11 that stores the target information on the target state of the work subject and the current state information on the current state of the work subject and the controller 12 that generates the work procedure information for causing the work robots 3 to perform the work of bringing the work subject close to the target state, on the basis of the target information and current state information, transmits the first work instruction information to be performed by the work robots 3 to the work robots 3 on the basis of the generated work procedure information, and, when it receives, from one of the work robots 3, the work completion information indicating that the work robot 3 has completed the work based on the first work instruction information earliest, transmits the second work instruction information next to the first work instruction information to the work robots 3. As seen above, in the present embodiment, the same type of instruction information is issued to all the work robots 3, which then start the same work all at once. When the work robot 3 that has completed the work earliest transmits the completion report, the controller 12 immediately generates the next instruction information in accordance with the current situation and transmits it to the work robots 3. Thus, the work robots 3 are allowed to perform work flexibly, that is, with a high degree of freedom. Note that the work completion information need not necessarily be received from the work robot 3 as described above and, for example, may be received on the basis of information detected by the external sensor 2.

### Second Embodiment

An information processing system according to a second embodiment will be described while focusing on the differences between it and that according to the first embodiment.

The information processing system according to the second embodiment differs from that according to the first embodiment in that work robots 3 coat a building. To coat the building, it is necessary to acquire information on the coating range and the specification of paint (given conditions) on the basis of the shape and current state of the building, which is a coating target (a need for coating, the type of paint, or the like). For this reason, the information processing system according to the second embodiment first performs the process of acquiring the given conditions of the building, which is the coating target.

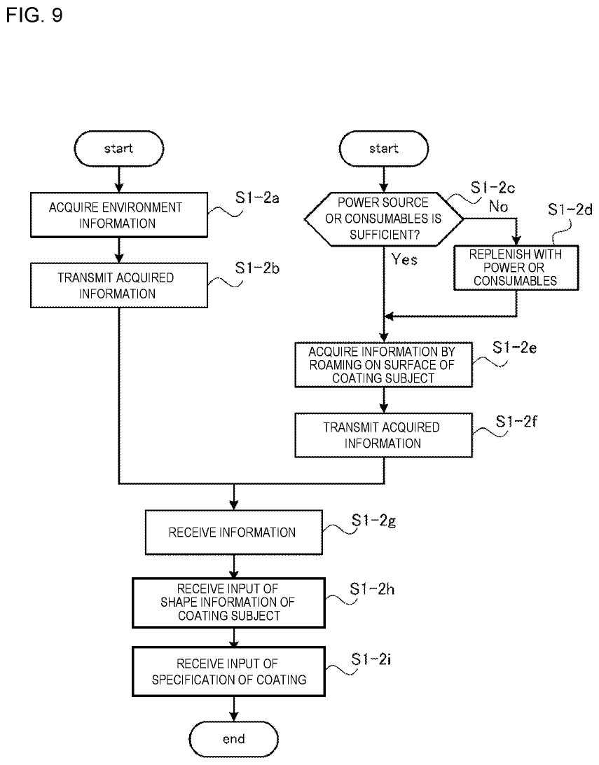

FIG. 9 is a flowchart showing the given conditions acquisition process (step S1) performed by the information processing device according to the second embodiment.

[Step S1-2a] An external sensor 2 acquires environment information such as image information, weather, atmospheric temperature, sunshine, and wind speed. Then, the process proceeds to step S1-2b.

[Step S1-2b] The external sensor 2 transmits the acquired environment information to an information processing device 1.

[Step S1-2c] The work robots 3 check the remaining amount of their power sources (rechargeable batteries) or the presence or absence of a problem such as a shortage of consumables. If there is a work robot 3 having a problem (NO in step S1-2c), the process proceeds to step S1-2d. If there is no work robot 3 having a problem (YES in step S1-2c), the process proceeds to step S1-2e.

[Step S1-2d] The work robot 3 moves to a charger 4 or consumables warehouse 5 and replenishes itself with power or consumables. Then, the process proceeds to step S1-2e.

[Step S1-2e] The work robots 3 roam on the surface of the coating target and acquire information on the coating target and the surrounding environment. Then, the process proceeds to step S1-2f. Examples of the information acquired include the shape, material, position, appearance, and missing portion of the coating target and the weather, atmospheric temperature, sunshine, and wind speed. The work robots 3 may also acquire information on the breeding of weeds, the presence or absence of fallen leaves, or the like by moving on the ground around the coating target.

[Step S1-2f] The work robots 3 transmit the acquired information to the information processing device 1. The work robots 3 acquire coordinate information by thoroughly roaming on the surface of the coating target and its vicinity and transmit it to the information processing device 1. As a result, the effect of acquiring shape information of the coating target is obtained as is done by a 3D scanner, and the coating target and its surrounding environment are reproduced in a virtual space by combining the shape information with image information or other information. The information processing device 1 may display this virtual space on the monitor 104a. As seen above, the work robots 3 serve as 3D scanners that detect the shape of a three-dimensional object. That is, the work robots 3 are able to acquire the current state information of the work subject.

[Step S1-2g] The controller 12 receives the information transmitted by the external sensor 2 and work robots 3. Then, the process proceeds to step S1-2h.

[Step S1-2h] The controller 12 receives input of the shape information of the coating target by the manager. Then, the process proceeds to step S1-2i. Note that the controller 12 may acquire the shape information of the coating target on the basis of the information acquired by the external sensor 2 and work robots 3.

[Step S1-2i] The controller 12 receives input of the specification of coating by the manager. Note that the controller 12 may determine the specification of coating on the basis of the information acquired by the external sensor 2 and work robots 3.

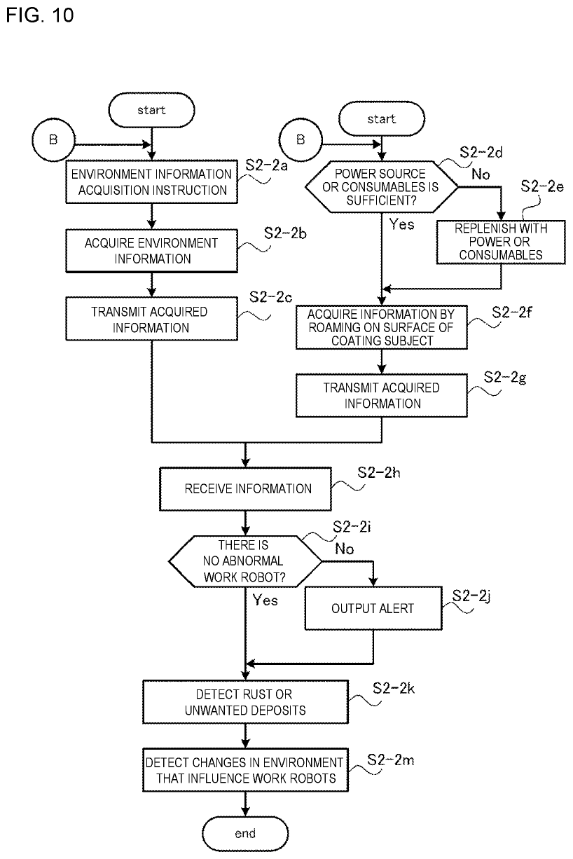

FIG. 10 is a flowchart showing the current state grasp process (step S2) according to the second embodiment. The processes of steps S2-2a to S2-2m according to the second embodiment are the same as the processes of steps S2-1a to S2-1m in FIG. 6 except that the work subject is the coating target in place of the building; the work is coating in place of the construction of the building; the error is, for example, the presence of rust or unwanted deposits in place of the presence of the discrepancy between the completed form and analysis results; the process of acquiring information by roaming on the surface of the coating target is included as step S2-2f; and the process of grasping the shape and state of the building of step S2-1j is not included.

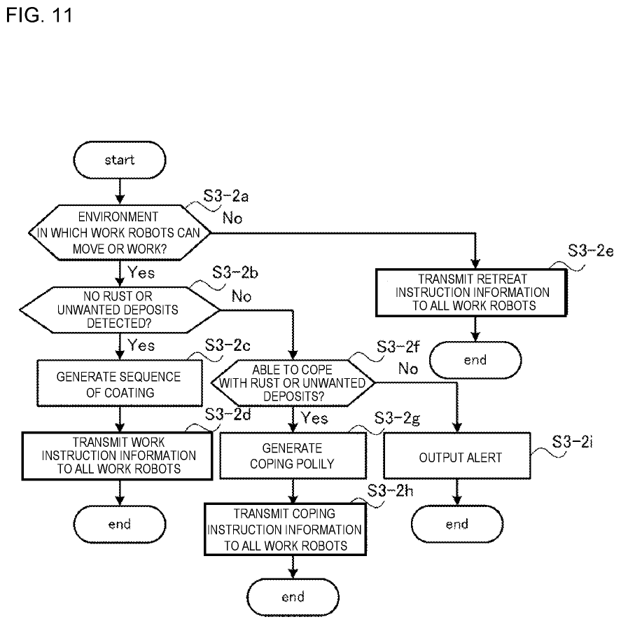

FIG. 11 is a flowchart showing a work sequence generation process and instruction information transmission process (step S3) according to the second embodiment. The processes of steps S3-2a to S3-2i according to the second embodiment are the same as those of steps S3-1a to S3-1i in FIG. 7 except that the work subject, the work, and the error are different. The information processing system 100 according to the second embodiment is able to obtain advantageous effects similar to those of the information processing system 100 according to the first embodiment.

### Third Embodiment

An information processing system according to a third embodiment will be described while focusing on the differences between it and those according to the first and second embodiments. One of the objects of the information processing system according to the third embodiment is to solve the following three problems.

(1) The pruning of planted plants, street trees, or the like: This is performed by personnel (workers) periodically or when necessary. Although planted plants or the like often grow densely, they are pruned only after they interfere with the appearance, sunshine, or nearby structures or harm the use of space or the growth, health, or the like of trees or the like.

While pruning is often performed using a method of dropping cut branches and leaves on the ground, this method involves the risk of physical injury or property damage, as well as the risk that the cut branches and leaves may collide with and thus damage other branches and leaves. Also, pruning is often work at height and therefore involves the risk of a fall accident, or physical injury or property damage by a falling object.

Use of a tool or machine in pruning involves the risk of physical injury. The work of planting street trees or the like around a place in which persons or vehicles come and go requires the restriction of passage or entry.

Pruning technique has yet to be sufficiently standardized, and the finished form greatly varies among workers. Inappropriate pruning is often performed at an inappropriate timing for the convenience of construction or work or due to a human error, a lack of technique or knowledge, or the like.

(2) Spraying of pesticide on planted plants, street trees, or the like: This is performed by personnel (workers) periodically or when necessary. Pesticide is often sprayed over a relatively wide range from outside the trees This often causes waste or inconsistency, as well as poses a risk to the health of third parties such as nearby residents, passers-by, or the like who are not equipped with a protector or the like against pesticide. Also, periodical spraying may become unnecessary spraying.
(3) Cut-down of planted plants, street trees, or the like: Methods for cut-down include a method of cutting off trees or the like from the top little by little using the same procedure as pruning, a method of cutting down trees or the like from near the root from the beginning, and a combination thereof.

As with pruning, cut-down involves the risk of physical injury by a tool or machine, the risk of physical injury or property damage by dropped branches or leaves or cut-down trunks, and the risk of a fall accident or physical injury or property damage by a falling object.

One of the objects of the information processing system according to the third embodiment is to solve the above (1) to (3) problems.

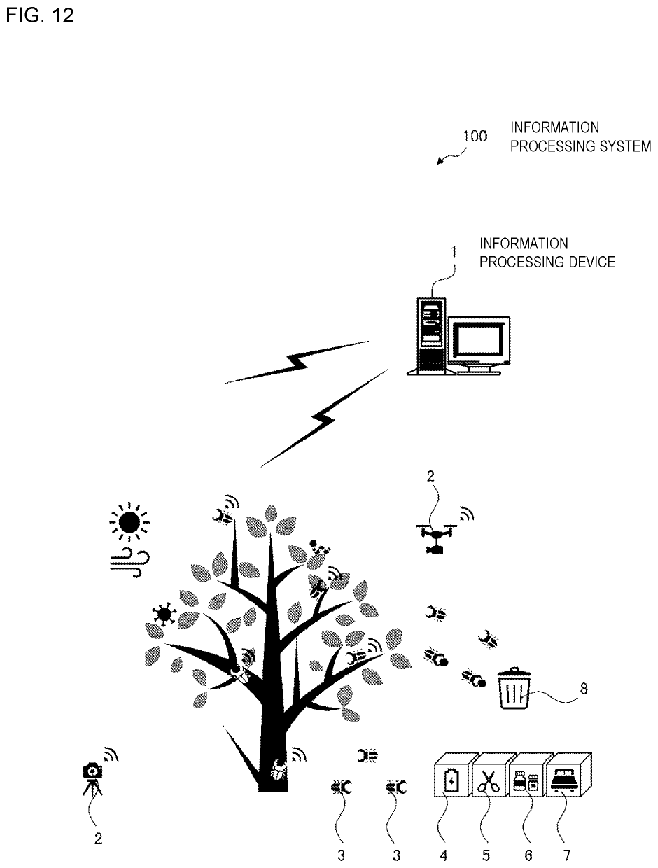

FIG. 12 is a drawing showing the information processing system according to the third embodiment. An information processing system 100 according to the third embodiment includes an information processing device 1, an external sensor 2, multiple work robots 3, a charger 4, a consumables warehouse 5, a repair unit 6, a storage 7, and a waste storage 8.

The information processing device 1 stores target information on the target state of the work subject and current state information on the current state of the work subject.

The work subject according to the third embodiment is, for example, trees. Examples of details of the work include pruning or cut-down of trees, pest control, spraying of pesticide, fertilization, weeding, and watering. In the present embodiment, it is assumed that the work subject is trees.

In the case of trees, the target information is shape information indicating that the branches, leaves, or the like of the trees are in the target shape. The current state information is information obtained by performing measurements or the like and, in the case of trees, is shape information of the current trees.

The work robots 3 need not necessarily have multiple functions during work. For example, the work robots 3 may have only a cutting function in addition to movement means. The consumables warehouse 5 is storing consumables (e.g., pesticide, repair agent, etc.) transported by the work robots 3.

Next, a process performed by the information processing system 100 according to the third embodiment will be described briefly. The information processing device 1 generates work procedure information for causing the work robots 3 to perform work for bringing the work subject close to the target information, on the basis of the current state information. For example, if there are branches that have grown excessively, the information processing device 1 generates first procedure information for cutting the branches. Next, if there are leaves that have grown excessively, the information processing device 1 generates second procedure information for removing the leaves, or the like.

The information processing device 1 transmits the first work instruction to be performed by the work robots 3 to the work robots 3 on the basis of the generated work procedure information. For example, the first work instruction information is information instructing the work robots 3 to move to the trees, to climb up the trees, to cut off predetermined branches by several millimeters, and to bring them back. For another example, the first work instruction information is information instructing the work robots 3 to move to the trees and to cut weeds around the trees into a predetermined length (e.g., 5 cm) or less.

The work robots 3 move toward the coordinates of the target trees in order to perform work all at once, on the basis of the first work instruction information. The work robots 3 then arrive at the target site and sequentially start to perform work. For example, three work robots 3 start to cut branches at different angles. If there are work robots 3 that are already located in the target site, other work robots 3 that have yet to arrive at the target site may wait near the target site. When the branch cutting load of the work robots 3 cutting the branches is reduced, the work robots 3 may determine that the work based on the first work instruction is complete.

When the information processing device 1 receives work completion information from a work robot 3 that has determined that it has completed the work based on the first work instruction information earliest among the work robots 3, it transmits second work instruction information next to the first work instruction information to the work robots 3. For example, the second work instruction information is information instructing the work robots 3 to move to the trees and to remove leaves. Thus, the work robots 3 move toward the target leaves in order to perform work all at once. Note that if there are multiple pieces of second work instruction information, for example, if there are leave removal work and pesticide spray work, the information processing device 1 may group the work robots 3 by work type and cause the groups to perform the work in parallel.

As seen above, the work robots 3 continue to perform the small units of work (the work of cutting off the branches little by little from the top, the work of spraying pesticide transported by themselves, the work of mowing weeds in an amount transportable by themselves at one time, etc.) so that the work subject is brought close to the target state, on the basis of the instruction information from the information processing device 1. Thus, the trees is kept in the target state.

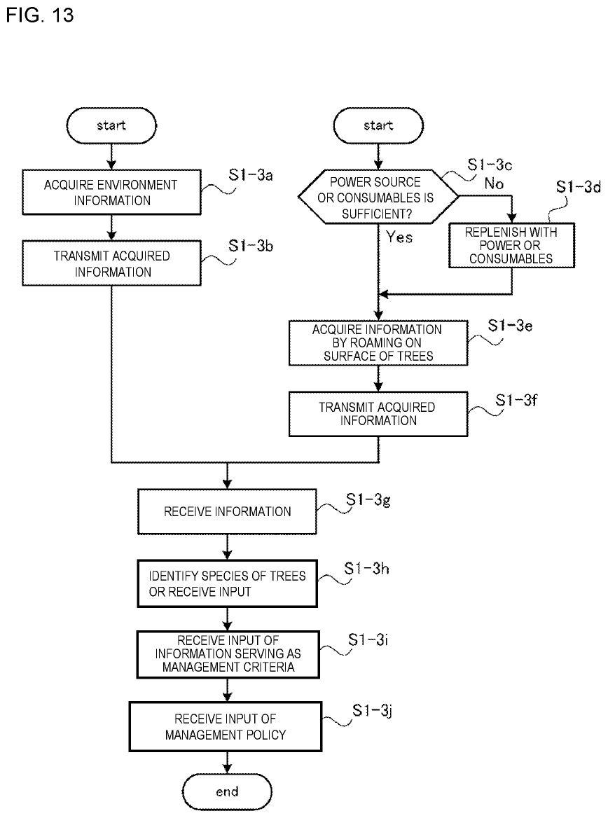

Next, the steps according to the third embodiment will be described in detail. FIG. 13 is a flowchart showing a given conditions acquisition process according to the third embodiment.

The processes of steps S1-3a to S1-3g according to the third embodiment are the same as those of steps S1-2a to S1-2g in FIG. 9 except that the work subject is trees in place of the building; the work is, for example, the pruning of trees in place of the construction of the building; the error is, for example, the presence of pests or disease in place of, for example, the presence of the discrepancy between the completed form and the analysis results; and a process of acquiring information by roaming on the surface of the trees is performed as step S1-3e.

[Step S1-3h] The controller 12 identifies the species of the trees on the basis of the information received in step S1-3g or receives input made by the manager. Then, the process proceeds to step S1-3i.

[Step S1-3i] The controller 12 receives input of information serving as management criteria by the manager. Then, the process proceeds to step S1-3j. Examples of the information inputted include sizes such as the tree height, branch width, and under-branch height. Note that the controller 12 may determine the optimum size or the like on the basis of information acquired by the external sensor or work robots 3.

[Step S1-3j] The controller 12 receives input of management policy by the manager. Examples of the management policy include policy related to the tree shape in pruning or the like, such as natural pruning, ball shape (“tamajitate”), cloud shape (“tamachirashi”), step shape (“danzukuri”), topiary, and hedge, as well as the density of branches or leaves and the priority of flowering or fruiting. Note that the controller 12 may determine the optimum management policy on the basis of information acquired by the external sensor 2 or work robots 3.

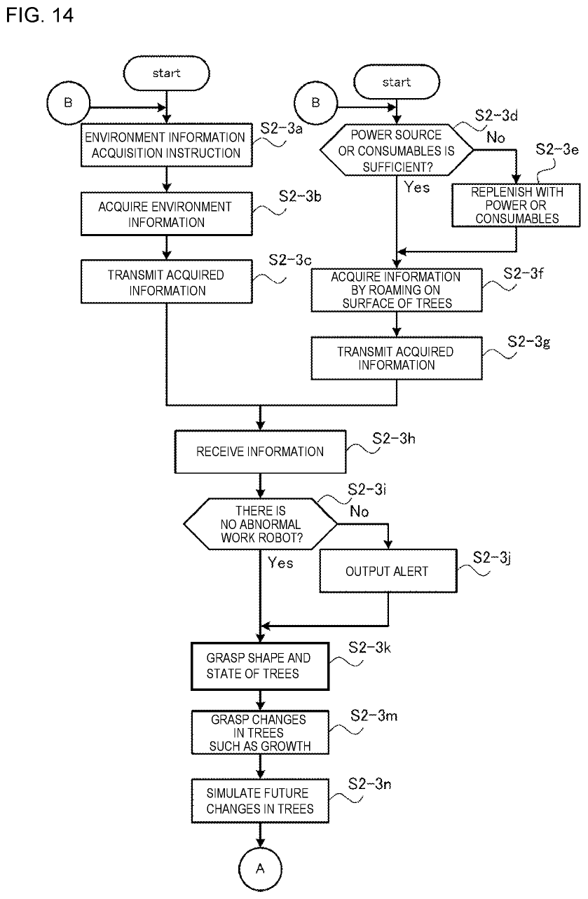

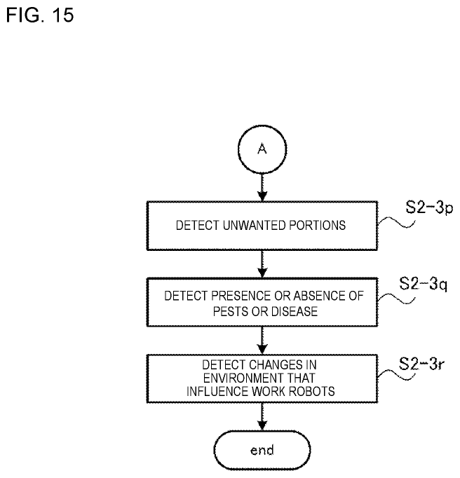

Next, the current state grasp process of step S2 according to the third embodiment will be described. FIGS. 14 and 15 are flowcharts showing the current state grasp process according to the third embodiment.

The processes of steps S2-3a to S2-3j according to the third embodiment are the same as those of steps S2-1a to S2-1i in FIG. 6 except that the work subject, the work, and the error are different; and a process of acquiring information by roaming on the surface of the trees is included as step S2-3f.

The processes of steps S2-3a to S2-3g may be performed each time, or may be performed when a predetermined period elapses after the given conditions acquisition process according to the third embodiment shown in FIG. 13. In other words, the processes of steps S2-3a to S2-3g may be omitted to perform the current state grasp process subsequent to the given conditions acquisition process according to the third embodiment shown in FIG. 13.

[Step S2-3k] The controller 12 grasps the shape and state of the trees by analyzing the information received in step S2-3h. Then, the process proceeds to step S2-3m.

[Step S2-3m] The controller 12 grasps changes in the trees such as growth on the basis of the information acquired in step S2-3k and the target information stored in the storage unit 11. Then, the process proceeds to step S2-3n.

[Step S2-3n] The simulator of the controller 12 simulates the future growth of the trees from the surrounding environment such as the weather, atmospheric temperature, sunshine, and wind, the differences in growth between the tree species, the health condition of the trees, or the like on the basis of the information acquired in step S2-3k and the target information stored in the storage unit 11. To perform simulation, necessary information about the characteristics of various tree species and various environments (the manner of growing, the time of flowering or fruiting, pests that tend to occur, etc.) may be previously inputted. Or, the information processing device 1 may be caused to actually collect the above-mentioned information. For example, the controller 12 may perform simulation using the previously inputted data, as well as information acquired from other systems in operation. The simulation accuracy can be expected to increase as information is accumulated.

[Step S2-3p] The work location detector of the controller 12 detects the work location on the basis of the results of the simulation. Examples of the work location include branches and leaves that impair the appearance, branches and leaves that impair sunshine inside the trunk, branches and leaves that interfere with other branches and leaves and buds that are expected to grow in such a manner in future, and withered or broken branches and leaves or buds.

[Step S2-3q] The controller 12 determines whether pests are adhering to the trees and whether any disease is occurring in the trees.

[Step S2-3r] The controller 12 detects changes in the environment that influence the work robots 3.

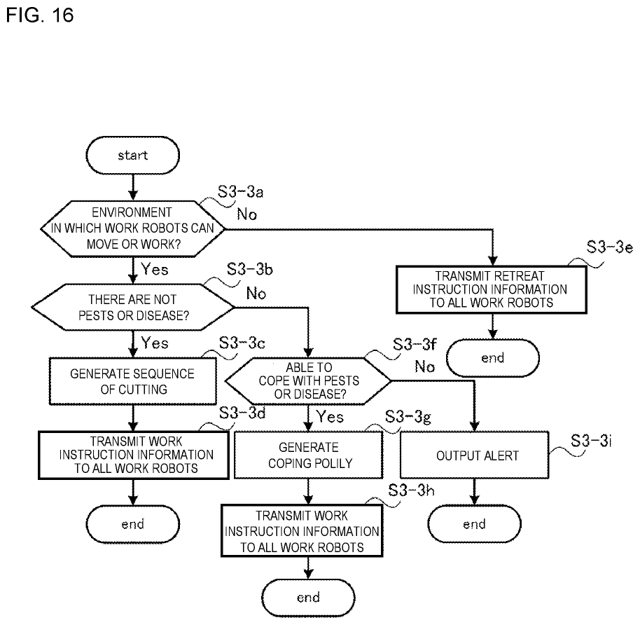

Next, the work sequence generation process and instruction information transmission process of step S3 according to the third embodiment will be described. FIG. 16 is a flowchart showing the work sequence generation process and instruction information transmission process according to the third embodiment.

The processes of steps S3-3a to S3-3i according to the third embodiment are the same as those of steps S3-1a to S3-1i in FIG. 7 except that the work subject, the work, and the error are different.

The information processing system 100 according to the third embodiment is able to obtain advantageous effects similar to those of the information processing systems 100 according to the first and second embodiments.

Note that the processes performed by the information processing device 1 may be performed by multiple devices in a distributed manner. For example, one device may perform processes until the given conditions acquisition process, and another device may perform the current state grasp process and later processes using the given conditions.

### Other Embodiments

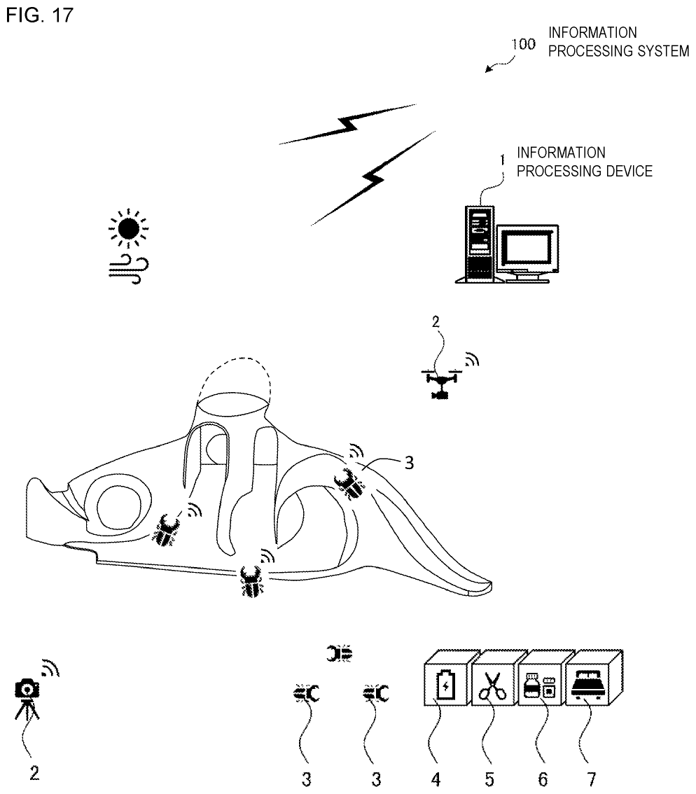

As shown in FIG. 17, in other embodiments, an art object that can also be used as play equipment installed in a square or the like (octopus-shaped object in an example of FIG. 17) may be constructed or repaired as the work subject. As seen above, a work management system according to the present invention is able to perform construction, repair, demolition, or the like of three-dimensional formed objects having any shape serving as the work subject on land, in the air, in the ground, underwater, in the deep sea, in outer space, or in other situations, including structures such as buildings and houses, civil engineering structures such as bridges, embankments, and dams, as well as furniture such as chest of drawers, desks, and shelves, play equipment such as slides and swings installed in parks, and art objects installed indoors or outdoors.

The work robots themselves may form a part of the work subject as a material. For example, when constructing a bridge as a work subject, the work robots may move to a specified site and may be incorporated into the bridge as a part of the bridge at that site.

Details of the work of the work robots are not limited to the embodiments. For example, the work robots may perform the work of removing deposits in the piping of a building. In this case, a comparison is made between current shape information and shape information indicating that there is no deposit in the piping, and the differences are regarded as deposits and removed.

Examples of details of the work of the work robots may include baking, welding, fitting, bonding, and sewing.

While the information processing device, information processing method, and program according to the present invention have been described on the basis of the shown embodiments, the present invention is not limited thereto and the components may be replaced with any components having similar functions. Also, any other components or steps may be added to the present invention. Also, the present invention may be a combination of any two or more components (characteristics) of the embodiments.

The above processing functions may be implemented by a computer. In this case, a program describing processing details of the functions of the information processing device 1 is provided. When the computer executes the program, the processing functions are implemented on the computer. The program describing the processing details may be stored in a computer-readable storage medium. Examples of the computer-readable recording medium include a magnetic storage device, an optical disc, a magneto-optical storage medium, and a semiconductor memory. Examples of the magnetic storage device include a hard disk drive, a flexible disk (FD), and a magnetic tape. Examples of the optical disc include a DVD, a DVD-RAM, and a CD-ROM/RW. Examples of the magneto-optical storage medium include a magneto-optical disc (MO).

A program may be distributed, for example, by selling portable storage media such as DVDs or CD-ROMs storing the program. Also, a program previously stored in the storage device of a server computer may be transferred to another computer through a network.

For example, a computer for executing a program stores, in its storage device, a program stored in a non-transitory portable storage medium or a program transferred from a server computer. The computer then reads the program from the storage device and performs processes in accordance with the program. The computer may directly read the program from the portable storage medium and perform processes in accordance with the program. Each time a program is transferred from the server computer connected to the computer through the network, the computer may perform processes in accordance with the received program.

At least some of the above-mentioned processing functions may be implemented by an electronic circuit such as a digital signal processor (DSP), application specific integrated circuit (ASIC), or programmable logic device (PLD).

### REFERENCE SIGNS LIST

1: information processing device, 2: external sensor, 3: work robot, 4: charger, 5: consumables warehouse, 6: repair unit, 7: storage, 8: waste storage, 11: storage unit, 12: controller, 13: information acquisition unit, 50: network, 100: information processing system, 101: CPU, 102: RAM, 103: hard disk drive, 104: graphics processor, 104a: monitor, 105: input interface, 105a: keyboard, 105b: mouse, 106: drive unit, 107: communication interface, 108: bus, 200: optical disc, 301: CPU, 302: RAM, 303: build-in memory, 304: movement means, 305: addition means, 306: communication interface, 307: GPS module, 308: bus, 309: rechargeable battery.

1. A work management system for managing work to be performed on a work subject, comprising:
a plurality of work robots;
a storage unit;
a generator; and
an instruction unit,
wherein the work robots each comprise movement means capable of moving to any location,
wherein the storage unit stores target information on a target state of the work subject and current state information on a current state of the work subject,
wherein the generator generates work procedure information indicating a work procedure to be performed by the work robots so that the work subject is brought close to the target state, on the basis of the target information and the current state information,
wherein the work procedure information comprises work instruction information for instructing the work robots to perform one or more types of work to be performed on the work subject, and
wherein the instruction unit transmits one piece of work instruction information to be performed by the work robots to the work robots on the basis of the work procedure information and, when receiving work completion information based on the work instruction information, transmits the next work instruction information on work to be performed subsequent to the work, to the work robots.

2. The work management system of claim 1, wherein the work procedure information comprises work instruction information on the same type of work to be repeatedly performed by the work robots.

3. The work management system of claim 1, further comprising:
a current state information acquisition unit; and
an external sensor, wherein
the current state information acquisition unit acquires the current state information on the basis of information detected by the external sensor.

4. The work management system of claim 1, wherein the work robots each serve as a 3D scanner for detecting a shape of a three-dimensional object.

5. The work management system of claim 1, wherein the work robots are able to perform at least one of walking, sliding, climbing, rolling, flying, swimming, diving, floating, and drilling using the movement means.

6. The work management system of claim 1, wherein the work subject comprises a building, a civil engineering structure, play equipment, furniture, and an art object.

7. A work management system for managing work to be performed on a tree, comprising:
a plurality of work robots;
a storage unit;
a generator; and
an instruction unit,
wherein the work robots each comprise movement means capable of moving to any location of the tree,
wherein the storage unit stores target information on a target state of the tree and current state information on a current state of the tree,
wherein the generator generates work procedure information indicating a work procedure to be performed by the work robots so that the tree is brought close to the target state, on the basis of the target information and the current state information,
wherein the work procedure information comprises work instruction information instructing the work robots to perform one or more types of work to be performed on the tree, and
wherein the instruction unit transmits one piece of work instruction information to be performed by the work robots to the work robots on the basis of the work procedure information and, when receiving work completion information based on the work instruction information, transmits the next work instruction information on work to be performed subsequent to the work to the work robots.

8. The work management system of claim 7, further comprising:
a simulator;
an external sensor; and
a work location detector,
wherein the simulator performs a simulation of the tree on the basis of information detected by the external sensor, and
wherein the work location detector detects a work location of the tree on the basis of a result of the simulation.

9. A program for causing a computer to function as a work management system for managing work to be performed on a work subject,
wherein the work management system comprises a plurality of work robots;
wherein the work robots each comprise movement means capable of moving to any location,
wherein the program causes the computer to a storage step, a generation step, and an instruction step,
wherein in the storage step, the program causes the computer to store target information on a target state of the work subject and current state information on a current state of the work subject,
wherein in the generation step, the program causes the computer to generate work procedure information indicating a work procedure to be performed by the work robots so that the work subject is brought close to the target state, on the basis of the target information and the current state information,
wherein the work procedure information comprises work instruction information for instructing the work robots to perform one or more types of work to be performed on the work subject, and
wherein in the instruction step, the program causes the computer to transmit one piece of work instruction information to be performed by the work robots to the work robots, on the basis of the work procedure information and to, when receiving work completion information based on the work instruction information, transmit the next work instruction information on work to be performed subsequent to the work to the work robots.

10. The program of claim 9, wherein
the work subject is a tree, and
the work robots each comprise movement means capable of moving to any location of the tree.
